(19) United States
(12) Patent Application Publication
(10) Pub. No.: US 2017/0277504 A1
(43) Pub. Date: Sep. 28, 2017

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventors: Kazunori HORIKIRI, Yokohama-shi (JP); Yuki NAKAMORI, Yokohama-shi (JP)

(73) Assignee: FUJI XEROX CO., LTD., Tokyo (JP)

(21) Appl. No.: 15/250,607

(22) Filed: Aug. 29, 2016

(30) Foreign Application Priority Data
Mar. 25, 2016 (JP) 2016-061191

(51) Int. Cl. G06F 3/14; G09G 5/38

(52) U.S. Cl. CPC G06F 3/1462; G09G 5/38; G09G 2340/0464; G09G 2320/103

(57) ABSTRACT

An information processing apparatus includes a receiving unit that receives an update notification of a content of a first sticky note attached to a mount, and a controller that controls display of the first sticky note so that, in a case where the first sticky note is being updated, the first sticky note is displayed in a manner indicating that the first sticky note is being updated.

### CROSS-REFERENCE TO RELATED APPLICATIONS

This application is based on and claims priority under 35 USC 119 from Japanese Patent Application No. 2016-061191 filed on Mar. 25, 2016.

### BACKGROUND

Technical Field

The present invention relates to an information processing apparatus, an information processing method, and a non-transitory computer readable medium.

### SUMMARY

According to an aspect of the invention, there is provided an information processing apparatus including a receiving unit that receives an update notification of a content of a first sticky note attached to a mount; and a controller that controls display of the first sticky note so that, in a case where the first sticky note is being updated, the first sticky note is displayed in a manner indicating that the first sticky note is being updated.

### BRIEF DESCRIPTION OF DRAWINGS

Exemplary embodiments of the present invention will be described in detail based on the following figures, wherein:

FIG. 1 is a configuration diagram conceptually illustrating modules in a configuration example of an exemplary embodiment;

FIG. 2 is an explanatory diagram illustrating a configuration example of a system using the exemplary embodiment;

FIGS. 3A, 3B, 3C, and 3D are other explanatory diagrams illustrating a configuration example of a system using the exemplary embodiment;

FIG. 4A is an explanatory diagram illustrating an example of a conference room, FIG. 4B is an explanatory diagram illustrating an example of use of a display device, and FIG. 4C is an explanatory diagram illustrating an example of use of a personal terminal using the exemplary embodiment;

FIG. 5 is an explanatory diagram illustrating an example of a data structure of a sticky note information table;

FIG. 6 is an explanatory diagram illustrating an example of a data structure of a mount information table;

FIG. 7 is a flowchart illustrating an example of a process performed by the exemplary embodiment;

FIG. 8 is a flowchart illustrating an example of another process performed by the exemplary embodiment;

FIG. 9 is a flowchart illustrating an example of still another process performed by the exemplary embodiment;

FIG. 10 is a flowchart illustrating an example of still another process performed by the exemplary embodiment;

FIG. 11 is an explanatory diagram illustrating an example of processing performed by the exemplary embodiment;

FIG. 12 is an explanatory diagram illustrating another example of processing performed by the exemplary embodiment;

FIG. 13 is an explanatory diagram illustrating still another example of processing performed by the exemplary embodiment;

FIG. 14 is an explanatory diagram illustrating still another example of processing performed by the exemplary embodiment;

FIG. 15 is an explanatory diagram illustrating still another example of processing performed by the exemplary embodiment;

FIG. 16 is an explanatory diagram illustrating still another example of processing performed by the exemplary embodiment;

FIG. 17 is a flowchart illustrating an example of still another process performed by the exemplary embodiment;

FIG. 18 is a flowchart illustrating an example of still another process performed by the exemplary embodiment; and

FIG. 19 is a block diagram illustrating an example of a hardware configuration of a computer that implements the exemplary embodiment.

### DETAILED DESCRIPTION

Hereinafter, examples of exemplary embodiments of the present invention will be described based on the drawings.

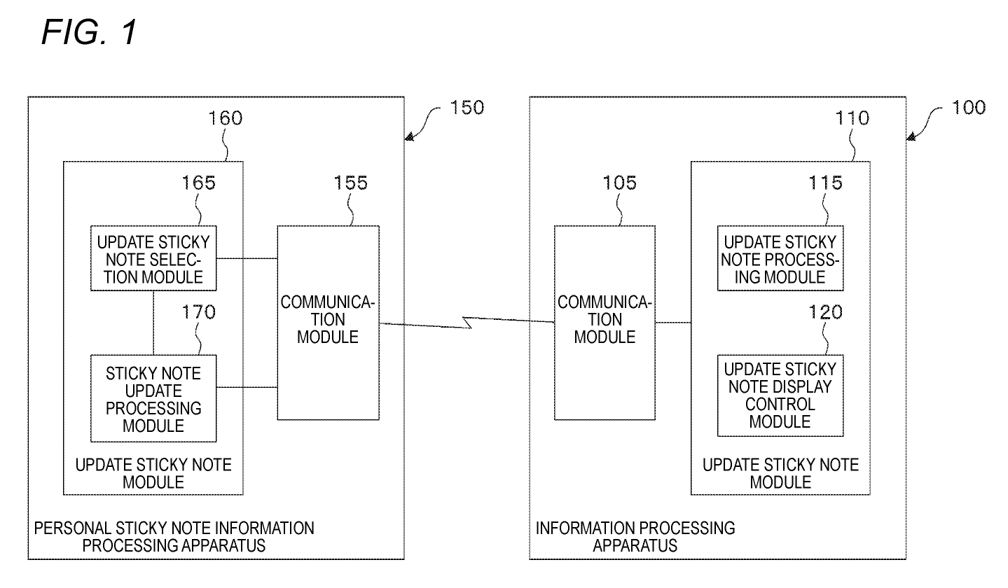

FIG. 1 is a configuration diagram conceptually illustrating modules in a configuration example of the present exemplary embodiment.

A module generally refers to logically divisible pieces of software (a computer program) or hardware or the like. Accordingly, the module in the present exemplary embodiment refers not only to a module in a computer program but also to a module in a hardware configuration. Therefore, in the present exemplary embodiment, a computer program that functions as the modules (a program for causing a computer to execute respective procedures, a program for causing a computer to function as respective units, a program for causing a computer to implement respective functions), a system, and a method are also described. For the convenience of explanation, the expressions of “stores”, “is stored”, and other expressions equivalent to the expressions are used. However, in a case where an exemplary embodiment is a computer program, these expressions mean that something is caused to be stored in a storage device or control is performed such that something is stored in the storage device. The module may have a one-to-one correspondence with a function. However, in mounting the modules, a single module may be implemented by a single program, plural modules may be implemented by a single program, and in an opposite manner, a single module may be implemented by plural programs. Furthermore, plural modules may be executed by a single computer or a single module may be executed by plural computers in a distributed or parallel environment. Other modules may be included in a single module. In the following, the expression “connection” is also used in a case of a logical connection (sending and receiving of data, issuing of instructions, reference relationship between data, or the like) in addition to a physical connection. The expression “predetermined” is used to include the meaning that matters are determined before processing in interest is performed, and matters are determined based on the situation and the state at that time or determined based on the situation and the state until that time before the processing in interest as the target is performed even after the processing in the present exemplary embodiment is started as well as before the processing in the present exemplary embodiment is started. In a case where there are plural “predetermined values”, the predetermined values may be respectively different values or two or more (also including all the values) of the predetermined values may be the same. The description having a meaning such that “In a case of A, do B” is used to mean that “It is determined whether it is A, and if it is determined that it is A, do B”. However, a case where the determination as to whether it is A is unnecessary is excluded.

A system or an apparatus is configured in such a way that plural computers, hardware, apparatuses or the like are connected to each other by a communication unit such as a network (including communication connection on one-to-one correspondence), and may be implemented by a single computer, hardware, apparatus or the like. The “apparatus” and the “system” are interchangeably used herein as having the same meaning. The “system” does not include a social “mechanism” (a social system) that is merely an artificial arrangement.

Target information is read from a storage device for each processing by each module or for each processing in a case where plural processing is performed in the module and a processing result is written into the storage device after the processing is performed. Accordingly, description of the reading from the storage device before the processing and the writing into the storage device after the processing may be omitted. Here, the storage device may include a hard disk, a random access memory (RAM), an external storage medium, a storage device through a communication line, a register within a central processing unit (CPU) or the like.

An information processing apparatus 100 which is an exemplary embodiment performs processing concerning an electronic sticky note (also called as an electronic card, but hereinafter referred to just as a “sticky note”) used in a meeting. As illustrated in the example of FIG. 1, the information processing apparatus 100 includes a communication module 105 and an update sticky note module 110. The information processing apparatus 100 is connected with a personal sticky note information processing apparatus 150 through a communication line.

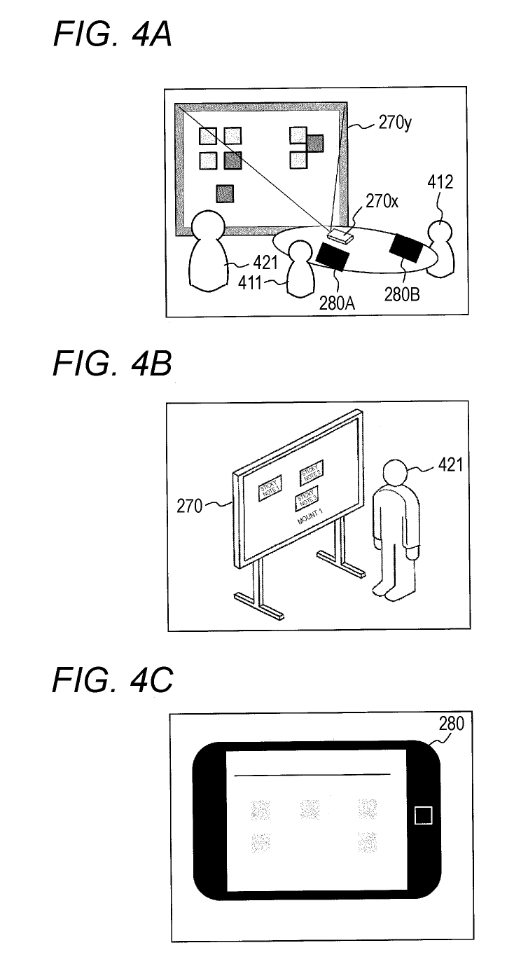

The information processing apparatus 100 is, specifically, used in a meeting (a workshop, a conference, an idea extraction meeting, an advisory meeting, or the like) performed by a facilitator (in general, a single person) and plural participants using the sticky notes. The participant creates a sticky note in which an idea or the like is described using a personal sticky note information processing apparatus 150 (which corresponds to a personal terminal 280 which will be described later) as a participant's terminal. In general, as illustrated in the example of FIG. 4, a personal terminal 280A, a personal terminal 280B, and the like (hereinafter, representatively referred to as a personal terminal 280) as the personal sticky note information processing apparatus 150 are present, and plural personal terminals 280 are present. The display device 270 receives a sticky note from the personal terminal 280 and attaches the sticky note on a mount (or background). A facilitator determines or alters a position of the sticky note or collects the sticky notes (associating a first sticky note with a second sticky note, which is referred to as grouping) on the mount, or creates information of the sticky note person, or the like, and makes a meeting progress using a shared screen of the display device 270. In the exemplary embodiment, the facilitator is included among the participants.

In general, a sticky note to which writing is completed is attached to the mount. That is, writing in the sticky note is performed first and attaching the sticky note to the mount is performed thereafter.

However, it may be intended that the writing of the sticky note is performed after the attachment position of the sticky note is secured depending on a meeting progress method and a participant's way of thinking. For example, it may be intended in a case where a participant receives impetus from the contents of a sticky note A and an idea arises, an assertion that a sticky note B, which is intended to be attached, exists in a position adjacent to the sticky note A is performed prior to writing which needs time. That is, the sticky note A and the sticky note B (however, a sticky note which is in a state of being unwritten) may be intended to be associated with each other. This is because, for example, a situation where the position of the sticky note A after the movement is required to be found out after the sticky note A is moved (actually, a situation where a sticky note is moved after another sticky note is attached frequently occurs) and writing in the sticky note B is made, occurs. In such a case, although the sticky note B itself is in a state of being unwritten, it is intended to secure an attachment position of the sticky note B.

When a blank paper or a sticky note which is undergoing writing is attached to the mount, it becomes hard to discern the blank paper or the sticky note and a sticky note in which writing is completed. For example, a situation where the sticky note which is undergoing writing is introduced occurs and the facilitator may be caught in a situation where the meeting is hardly progressed.

In the exemplary embodiment, in a case where an update notification of the contents of the sticky note is received after the sticky note is attached to the mount, a display form is controlled to be a display form indicating that the sticky note is being updated.

The communication module 105 is connected with the update sticky note module 110 and also connected with a communication module 155 of the personal sticky note information processing apparatus 150 through a communication line. The communication module 105 communicates with the personal sticky note information processing apparatus 150. For example, the communication module 105 receives the sticky note or the like from the personal sticky note information processing apparatus 150.

The update sticky note module 110 includes an update sticky note processing module 115 and an update sticky note display control module 120, and is connected with the communication module 105.

The update sticky note processing module 115 receives an update notification of contents of the sticky note, which is attached on the mount, through the communication module 105. That is, the update sticky note processing module 115 receives an update notification of contents of the sticky note after “the sticky note is attached to the mount”. The sticky note may be a blank paper sheet or a paper sheet which is undergoing writing.

In a case where the update notification of the contents of the sticky note is received from the update sticky note processing module 115, the update sticky note display control module 120 controls the display form of the sticky note which is set as a target to indicate that the sticky note is being updated.

The update sticky note display control module 120 may perform control such that a position of the sticky note which is set as a target is fixed until the update of the sticky note is completed. That is, the movement of the sticky note is not allowed until the writing into the sticky note is completed.

In a case where the sticky note B associated with the sticky note A which is set as a target is moved, the update sticky note display control module 120 may control display such that the sticky note A is moved while maintaining a positional relationship between the sticky note A and the sticky note B. That is, the sticky note A is moved while maintaining a positional relationship between the sticky note A and the sticky note B with the movement of the sticky note B. Here, the sticky note A is being updated.

The personal sticky note information processing apparatus 150 includes the communication module 155 and an update sticky note module 160.

The communication module 155 is connected with an update sticky note selection module 165 and a sticky note update processing module 170, and also connected with the communication module 105 of the information processing apparatus 100 through the communication line. The communication module 155 communicates with the information processing apparatus 100. For example, the communication module 155 transmits the sticky note or the like to the information processing apparatus 100.

The update sticky note module 160 includes an update sticky note selection module 165, and the sticky note update processing module 170.

The update sticky note selection module 165 is connected with the communication module 155 and the sticky note update processing module 170. The update sticky note selection module 165 selects a sticky note to be updated from the sticky notes attached to the mount. The sticky note which is a selection target may be a sticky note into which writing is completed in addition to a sticky note of a blank paper and a sticky note which is undergoing writing. This is because there may be a case where the sticky note is intended to be corrected.

The sticky note update processing module 170 is connected with the communication module 155 and the update sticky note selection module 165. The sticky note update processing module 170 performs writing into the sticky note selected by the update sticky note selection module 165. The writing may be writing of text using a keyboard or the like, writing of figure data using an electronic pen or the like, or writing of image data. Data which is being written may be transmitted to the information processing apparatus 100 through the communication module 155 or may be transmitted to the information processing apparatus 100 after the writing is completed.

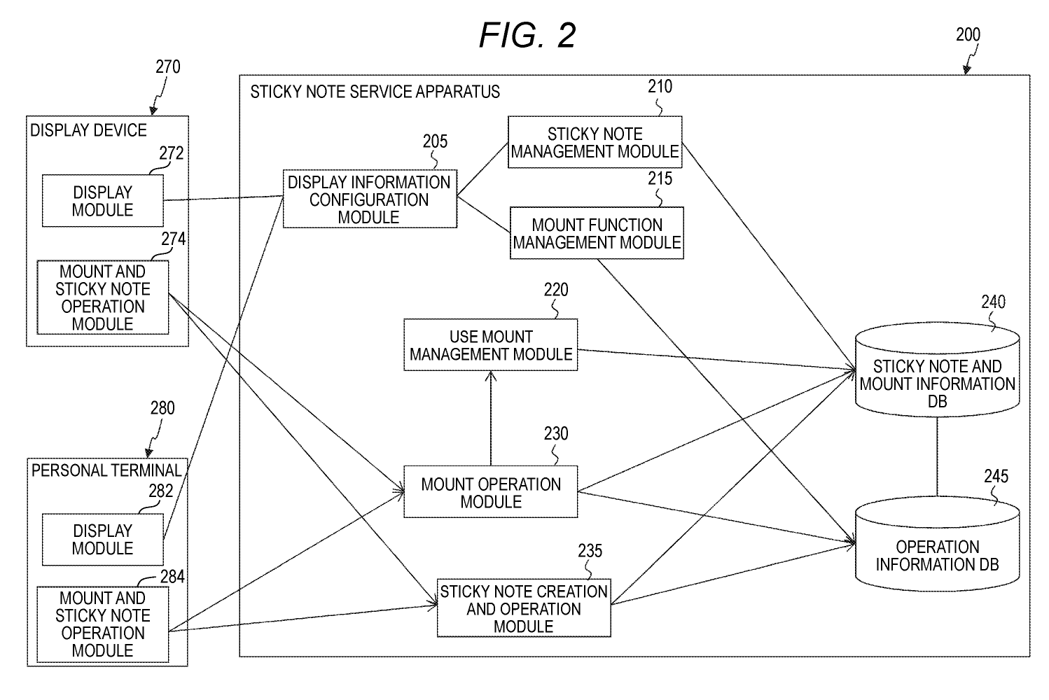

FIG. 2 is an explanatory diagram illustrating a configuration example of a system using the exemplary embodiment. In the configuration example, the system includes a sticky note service apparatus 200, a display device 270, and a personal terminal 280.

The sticky note service apparatus 200 includes a display information configuration module 205, a sticky note management module 210, a mount function management module 215, a use mount management module 220, a mount operation module 230, a sticky note creation and operation module 235, a sticky note and mount information DB 240, and an operation information DB 245. The sticky note service apparatus 200 represents a configuration in which the update sticky note module 110 of the information processing apparatus 100 illustrated in FIG. 1, is incorporated in the sticky note service apparatus 200 as the mount operation module 230. That is, modules within the update sticky note module 110 are included in the mount operation module 230.

The display information configuration module 205 is connected with the sticky note management module 210, the mount function management module 215, the display module 272 of the display device 270, and the display module 282 of the personal terminal 280. The display information configuration module 205 creates display information (display image) such as a sticky note attached to the mount and displays the display information on a display device, such as a liquid crystal display, of the display device 270 or the personal terminal 280.

The sticky note management module 210 is connected with the display information configuration module 205 and the sticky note and mount information DB 240. The sticky note management module 210 manages the sticky note created by the personal terminal 280 or the display device 270.

The mount function management module 215 is connected with the display information configuration module 205 and the operation information DB 245. The mount function management module 215 manages a function of the mount using in the meeting. For example, the mount function management module 215 controls a position at which the sticky note is attached according to the mount.

The use mount management module 220 is connected with the mount operation module 230 and the sticky note and mount information DB 240. The use mount management module 220 manages the mount which is used in the meeting. For example, the use mount management module 220 uses the mount selected from the operation of the display device 270 by the user (mainly, a facilitator).

The mount operation module 230 is connected with the use mount management module 220, the sticky note and mount information DB 240, the operation information DB 245, the mount and sticky note operation module 274 of the display device 270, and the mount and sticky note operation module 284 of the personal terminal 280. The mount operation module 230 performs processing on the mount according to the operation of the display device 270 or the personal terminal 280 by the user. Processing is performed according settings of the mount, a replacement of the mount, or a function of the mount itself in a case where the mount has the function (for example, as described above, control of a position to which the sticky note is to be attached).

The sticky note creation and operation module 235 is connected with the sticky note and mount information DB 240, the operation information DB 245, the mount and sticky note operation module 274 of the display device 270, and the mount and sticky note operation module 284 of the personal terminal 280. The sticky note creation and operation module 235 creates the sticky note, edits the contents of the sticky note, operates (moves, expands and reduces, alters a display form (including shape, pattern, or color, or a combination of these, or dynamic change (for example, flash, animation, or the like) of shape, pattern or color), grouping, or the like) of the sticky note, or the like according to the operation of the display device 270 or the personal terminal 280 by the user. Accordingly, the mount operation module 230 has a function of the information processing apparatus 100 illustrated in the example of FIG. 1 described above.

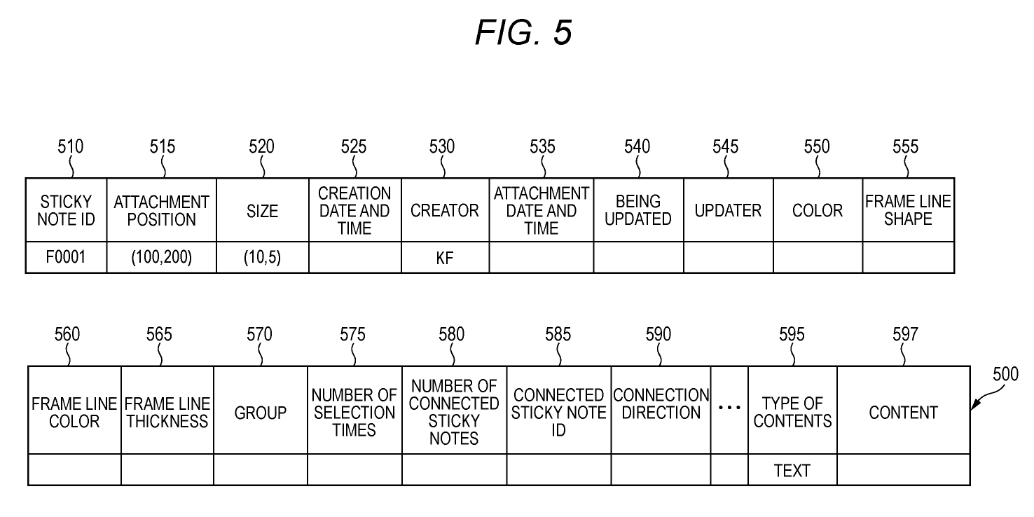

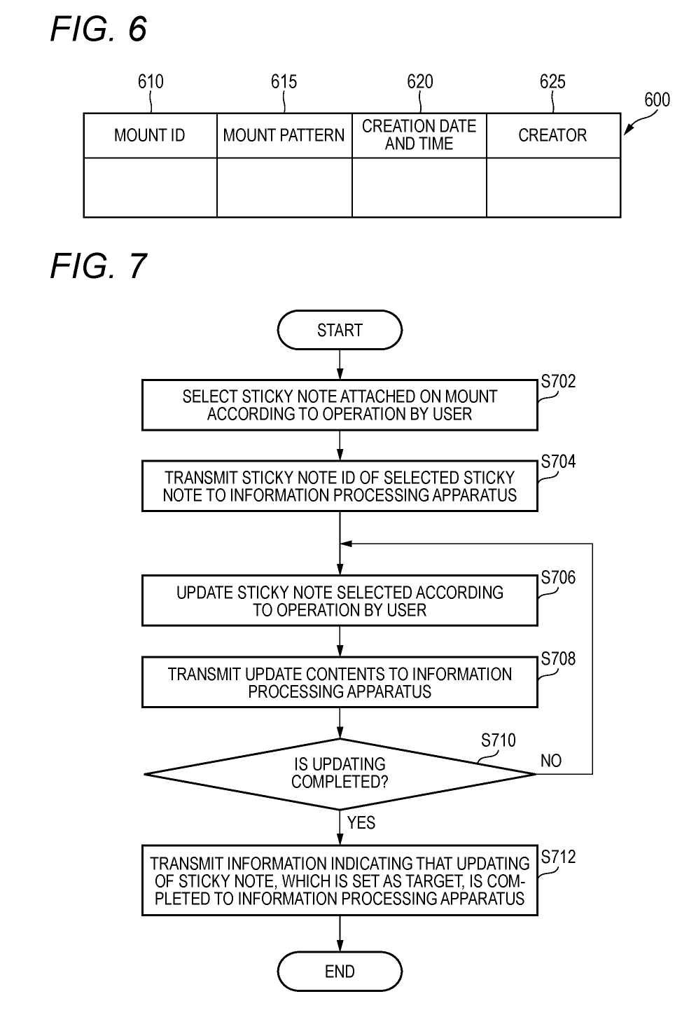

The sticky note and mount information DB 240 is connected with the sticky note management module 210, the use mount management module 220, the mount operation module 230, the sticky note creation and operation module 235, and the operation information DB 245. The sticky note and mount information DB 240 includes attribute information. For example, a sticky note information table 500 illustrated in FIG. 5 and a mount information table 600 illustrated in the example of FIG. 6 are stored in the sticky note and mount information DB 240.

FIG. 5 is an explanatory diagram illustrating an example of a data structure of the sticky note information table 500. The sticky note information table 500 includes a sticky note ID field 510, an attachment position field 515, a size field 520, a creation date and time field 525, a creator field 530, an attachment date and time field 535, a being updated field 540, an updater field 545, a color field 550, a frame line shape field 555, a frame line color field 560, a frame line thickness field 565, a group field 570, the number of selection times field 575, the number of connected sticky notes field 580, a connected sticky note ID field 585, a connection direction field 590, a type of contents field 595, and a contents field 597. In the exemplary embodiment, information (sticky note identification (ID)) for uniquely identifying the sticky note is stored in the sticky note ID field 510. A position where the sticky note is attached is stored in the attachment position field 515. That is, a position on a mount is stored in the attachment position field 515. The position is, for example, the coordinates in the XY-coordinate system of the mount. Specifically, the position is specified by movement processing performed by the sticky note creation and operation module 235. A size of the sticky note is stored in the size field 520. For example, in a case where the sticky note intended to be displayed is a rectangle, the width and height of the sticky note is stored in the size field 520. A date and time at which the sticky note is created (year, month, day, time, minute, second, smaller unit than a second, or a combination thereof) are stored in the creation date and time field 525. A creator (creator ID) of the sticky note is stored in the creator field 530. Otherwise, an information processing apparatus by which the sticky note is created (a device ID of the personal terminal 280 or the shared sticky note display device 270) may be stored in the creator field 530. A date and time at which the sticky note is attached on the mount is stored in the attachment date and time field 535. Information (flag) indicating whether the sticky note is being updated or not is stored in the being updated field 540. The updater (user ID) who performs the updating is stored in the updater field 545. The updater may be either a single person or persons. A display color of the sticky note is stored in the color field 550. The display color includes, for example, a color indicating that the sticky note is being updated. A frame line shape (a solid line, a dotted line, a broken line, a wavy line, double lines) in displaying the sticky note is stored in the frame line shape field 555. The frame line shape includes, for example, a frame line shape indicating that the sticky note is being updated. A frame line color in displaying the sticky note is stored in the frame line color field 560. The frame line color includes, for example, a color indicating that the sticky note is being updated. A frame line thickness in displaying the sticky note is stored in the frame line thickness field 565. The frame line thickness includes, for example, a frame line thickness indicating that the sticky note is being updated. Information relating to a group to which the sticky note belongs is stored in the group field 570. For example, information, which indicates whether the sticky note belongs to a group or not, may be stored in the group field 570. In a case where the sticky note belongs to the group, a group ID, an ID of another sticky note which belongs to the group, or the like may be stored in the group field 570. The number of times the sticky note is selected is stored in the number of selection times field 575. The number of selection times is, for example, the number of times the sticky note is selected by a topic selecting operation. The number of sticky notes connected to the selected sticky note is stored in the number of connected sticky notes field 580. The next connected sticky note ID field 585 and the next connection direction field 590 may be repeated by the number of connected sticky notes. A sticky note ID of a sticky note connected to the selected sticky note is stored in the connected sticky note ID field 585. The connected sticky note ID is used for extracting, for example, a second sticky note related to a sticky note which is a target. A connection direction of the sticky note of the connection direction field 590 and the sticky note of the immediately preceding connected sticky note ID field 585 is stored in the connection direction field 590. The connection direction may be either information indicating that the sticky note (or the sticky note of the immediately preceding connected sticky note ID field 585) is located at an upstream (connection source)/downstream (connection destination) side or the sticky note ID of the sticky note located at an upstream (or downstream) side. In a case of non-directional connection, the connection direction field 590 may be empty (NULL) and may be made unnecessary. The connection direction indicates, for example, a positional relationship between the sticky note regarded to be updated and a second target related to the target. In a case where the second target moves, the second target is moved while maintaining the positional relationship. A type of the contents of the sticky note (text information, vector data indicating handwriting characters, figures or the like, voice information, information of a still image such as a photograph, information of a moving image, or information indicating a combination thereof) is stored in the type of contents field 595. The contents written into the sticky note is stored in the contents field 597. In a state where the sticky note is not attached on the mount, the attachment position field 515 may be empty (NULL) and may contain a predetermined value (default value).

FIG. 6 is an explanatory diagram illustrating an example of a data structure of the mount information table 600. The mount information table 600 includes a mount ID field 610, a mount pattern field 615, a creation date and time field 620, and a creator field 625. Information (mount ID) for uniquely identifying the mount is stored in the mount ID field 610 in the exemplary embodiment. A mount pattern is stored in the mount pattern field 615. For example, the mount pattern includes a blank paper, a pattern of a table format, or the like. In particular, in a case of a pattern of a table format, control is performed such that the sticky note is attached to a cell within the table as described above. A creation date and time of the mount is stored in the creation date and time field 620. A creator of the mount is stored in the creator field 625.

The operation information DB 245 is connected with the mount function management module 215, the mount operation module 230, the sticky note creation and operation module 235, and the sticky note and mount information DB 240. An operation history is stored in the operation information DB 245. The history of operations is, for example, a log table in which a history ID field, a date and time field, a target field, an operator field, an operation field, and a movement field (the movement field is constituted with a movement source position field, a movement destination position field, and a distance field). Information (history ID) for uniquely identifying the history is stored in the history ID field in the exemplary embodiment. A date and time at which the history occurs (or the operation is performed) is stored in the date and time field. A target of the operation (sticky note ID, mount ID, or the like) is stored in the target field. An operator who performs the operation is stored in the operator field. An operation is stored in the operation field. Information related to a movement operation is stored in the movement field. A movement source position (coordinates) is stored in the movement source position field. A movement destination position (coordinates) is stored in the movement destination position field. A distance is stored in the distance field. The distance may be a distance of a straight line or an actual movement distance (For example, in a case where the movement operation is performed in a zig-zag pattern, the length of the locus of the zig-zag movement).

The display device 270 includes the display module 272 and the mount and sticky note operation module 274. The display device 270 is mainly used by the facilitator and is provided with, for example, a large screen liquid crystal display, so as to make it easier for the participant to see.

The display module 272 is connected with the display information configuration module 205 of the sticky note service apparatus 200. The display module 272 performs a display control by the display information configuration module 205 of the sticky note service apparatus 200 or displaying on the display device 270 depending on the operation by the user or the like.

The mount and sticky note operation module 274 is connected with the mount operation module 230 and the sticky note creation and operation module 235 of the sticky note service apparatus 200. The mount and sticky note operation module 274 receives the operation to the mount and the sticky note by the user as an input and transmits the operation to the mount operation module 230 or the sticky note creation and operation module 235 of the sticky note service apparatus 200 depending on whether the operation target is the mount or the sticky note.

The personal terminal 280 includes the display module 282 and the mount and sticky note operation module 284. The personal terminal 280 is used by a meeting participant and includes, for example, a tablet type terminal or the like in order to make it easier for the participant to handle.

The personal terminal 280 represents a configuration in which the update sticky note module 160 of the personal sticky note information processing apparatus 150 illustrated in FIG. 1 is incorporated in the personal terminal 280 as the mount and sticky note operation module 284. That is, the modules within the update sticky note module 160 are included in the mount and sticky note operation module 284.

The display module 282 is connected with the display information configuration module 205 of the sticky note service apparatus 200. The display module 282 performs a display control by the display information configuration module 205 of the sticky note service apparatus 200 or displaying on the personal terminal 280 depending on the operation by the user or the like.

The mount and sticky note operation module 284 is connected with the mount operation module 230 and the sticky note creation and operation module 235 of the sticky note service apparatus 200. The mount and sticky note operation module 284 receives the operation to the mount and the sticky note by the user as an input and transmits the operation to the mount operation module 230 or the sticky note creation and operation module 235 of the sticky note service apparatus 200 depending on whether the operation target is the mount or the sticky note.

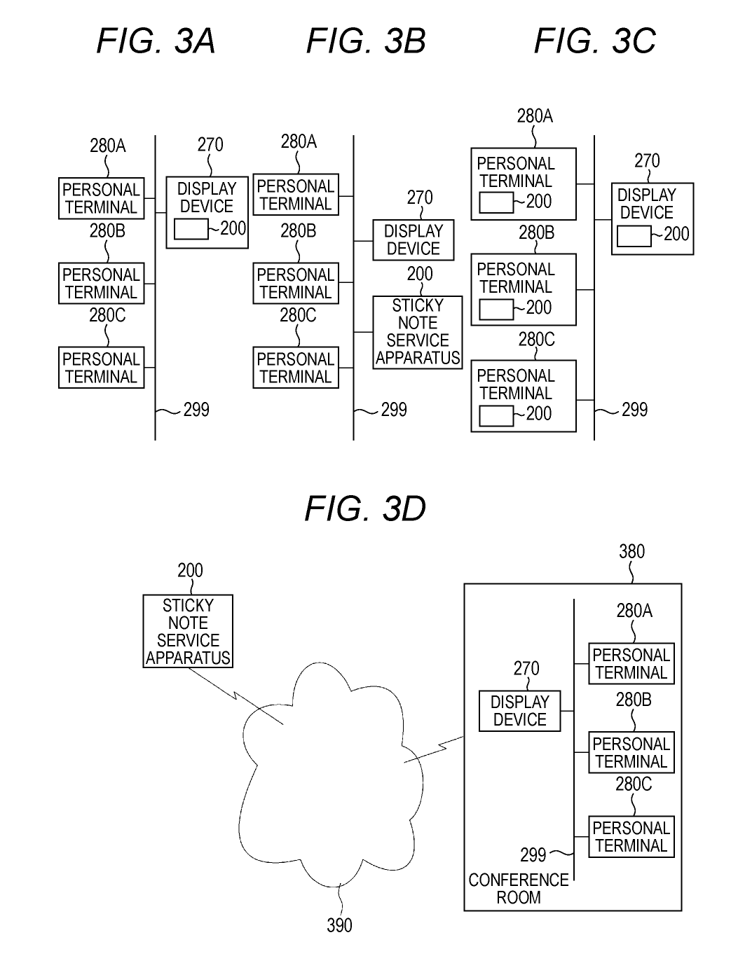

FIGS. 3(a1), 3(a2), 3(a3), and 3(b) is an explanatory diagram illustrating a configuration example of a sticky note system using the exemplary embodiment. The display device 270 is, in general, provided with a large screen display device and is operated by the facilitator. The display device is adapted to be able to seen by all participants. Each personal terminal 280 is operated by each participant in the meeting and, in general, each participant owns a single personal terminal. For example, a tablet-type terminal or the like is used as the personal terminal 280.

In the example of FIG. 3A, the display device 270 includes the sticky note service apparatus 200. The display device 270, the personal terminal 280A, the personal terminal 280B, and the personal terminal 280C are connected with each other through a communication line 299. The communication line 299 may be a wired communication network, a wireless communication network, or a combination of the wired communication network and the wireless communication network, and may be, for example, the Internet and the Ethernet as a communication infrastructure. In this case, the sticky note service apparatus 200 performs processing on the mount and the sticky note displayed on the screen of the display device 270. The sticky note service apparatus 200 transmits displayed contents of the screen of the display device 270 to each personal terminal 280.

In the example of FIG. 3B, the sticky note service apparatus 200, the display device 270, the personal terminal 280A, the personal terminal 280B, and the personal terminal 280C are connected with each other through the communication line 299. In this case, the display device 270 and each personal terminal 280 use the sticky note service apparatus 200 through the communication line 299. The mount and the sticky note are displayed on the screen of the display device 270 and the screen of each personal terminal 280 according to the control of the sticky note service apparatus 200. The function by the sticky note service apparatus 200 may be implemented by a cloud service.

In the example of FIG. 3C, the display device 270 and each personal terminal 280 include the sticky note service apparatus 200, respectively. The display device 270, the personal terminal 280A, the personal terminal 280B, and the personal terminal 280C are connected with each other through the communication line 299. In this case, each sticky note service apparatus 200 performs processing on the mount and the sticky note displayed on the screen of each of the sticky note information processing apparatuses (display device 270 and each personal terminal 280).

In the example of FIG. 3D, the display device 270, the personal terminal 280A, the personal terminal 280B, and the personal terminal 280C are installed in a conference room 380 and the meeting is performed. The display device 270, the personal terminal 280A, the personal terminal 280B, and the personal terminal 280C are connected with each other through a communication line 299.

The sticky note service apparatus 200 and devices installed within the conference room 380 are connected with each other through a communication line 390. The communication line 390 may be a wired communication network, a wireless communication network, or a combination of the wired communication network and the wireless communication network, and may be, for example, the Internet and the Ethernet as a communication infrastructure. The function by the sticky note service apparatus 200 may be implemented by a cloud service. The display device 270 may transmit displayed contents of the screen of the display device 270 to the personal terminal 280 using the sticky note service apparatus 200 so as to cause the displayed contents of the screen to be displayed on the screen of each personal terminal 280. The display device 270 and each personal terminal 280 may be adapted to use the sticky note service apparatus 200.

FIG. 4A is an explanatory diagram illustrating a conference room, FIG. 4B is an explanatory diagram illustrating an example of use of a display device 270, and FIG. 4C is an explanatory diagram illustrating an example of use of a personal terminal 280.

As illustrated in the example of FIG. 4A, participants 411 and 412 and a facilitator 421 are gathered in a conference room or the like. The participant 411 uses the personal terminal 280A and the participant 412 uses the personal terminal 280B. In general, a single terminal device (personal terminal 280A or the like) is given to a single participant.

As illustrated in the example of FIG. 4C, the terminal device is a tablet type terminal having a size (For example, A4 size, B5 size, 7-inch to 10-inch size, or the like) in the order of a notebook computer like the personal terminal 280, and is operated using human fingers, an electronic pen, or the like. Information of the sticky note in which text data, handwritten characters, figures or the like is described is created by the participant. Similar to the display device 270, the sticky note attached on the mount is displayed on the screen of the personal terminal 280. The terminal device is not limited to a tablet type terminal and may be a PC (including a notebook PC or the like) equipped with a keyboard, a mouse, or the like.

A display device 270x illustrated in the example of FIG. 4A is a projector and displays a mount and a sticky note. A display device 270y is an electronic blackboard and detects movements of fingers of a facilitator 421 or the electronic pen, and receives the operation such as attaching of the sticky note to the mount (front surface), movement of the sticky note, associating of sticky notes with each other (grouping), or the like. As illustrated in the example of FIG. 4A, the sticky note is displayed on the mount in the display device 270y. For example, the display device 270y is provided with an electronic pen and receives the operation to the mount and the sticky note by detecting detachment of the pen from a predetermined placement of the pen (lifting up of the pen by the facilitator 421 in order to perform the operation) and a position of the tip end of the pen (a situation where the tip end of the pen contacts with the display device 270y). For example, a sensor may be provided in the placement of the pen (a sensor causing a switch to be turned on and off by gravity of the pen or the like) and may detect that which pen of plural pens (a black pen, red pen, blue pen, or the like) is used. A display screen of the display device 270y may be a touch sensor in its entirety and may detect a position, at which contact is made, on the display screen and contact pressure on the display screen.

The display device 270 may be the electronic board as illustrated in the example of FIG. 4B. In general, an electronic board is provided with a display device having a large screen (of which size is at least larger than the display device of the personal terminal 280). The display device is a touch panel and detects a position, at which contact is made, on the display screen and contact pressure on the display screen. For example, the electronic board may be provided with a screen having a size of 80-inch or the like.

FIG. 7 is a flowchart illustrating an example of a process performed by the exemplary embodiment (personal sticky note information processing apparatus 150).

In Step S702, the update sticky note selection module 165 selects the sticky note attached on the mount according to the operation by the user.

In Step S704, the update sticky note selection module 165 transmits a sticky note ID of the selected sticky note to the information processing apparatus 100.

In Step S706, the sticky note update processing module 170 updates the selected sticky note according to the operation by the user. For example, the update performed by the sticky note update processing module 170 corresponds to adding, correcting, or deleting of text with respect to the contents written in the sticky note.

In Step S708, the sticky note update processing module 170 transmits the update contents to the information processing apparatus 100.

In Step S710, the sticky note update processing module 170 determines whether the updating is completed or not. In a case where the updating is completed, the process proceeds to Step S712 and otherwise, the process proceeds to Step S706. A case of the completion of update may include, for example, a case where pressing of an update end button is detected and a case where other sticky note is selected.

In Step S712, the sticky note update processing module 170 transmits information indicating that the update of the sticky note, which is a target, is completed to the information processing apparatus 100.

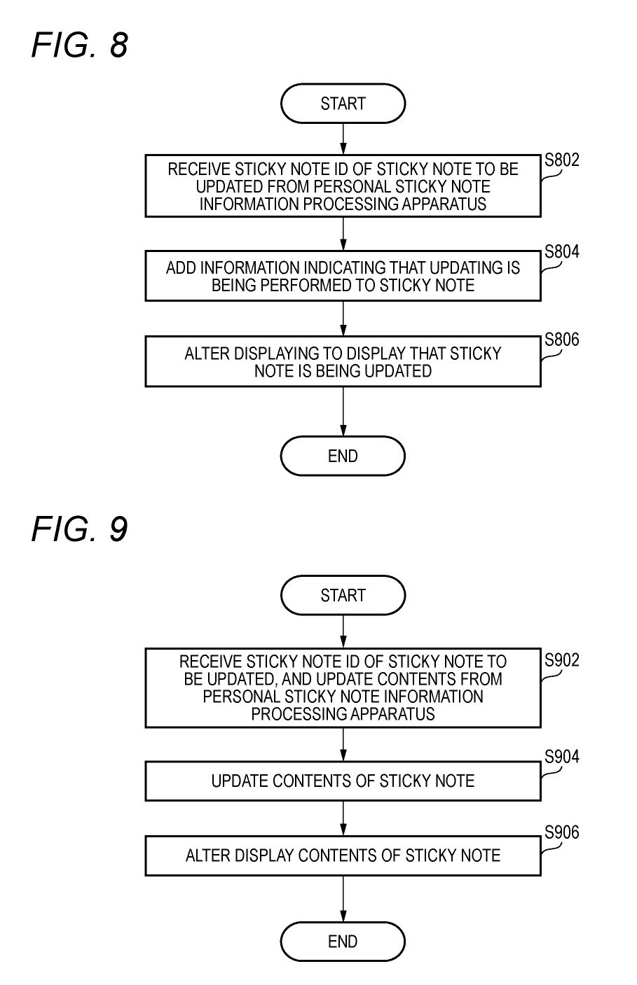

FIG. 8 is a flowchart illustrating an example of another process performed by the exemplary embodiment (information processing apparatus 100).

In Step S802, the update sticky note processing module 115 receives a sticky note ID of a sticky note to be updated from the personal sticky note information processing apparatus 150.

In Step S804, the update sticky note processing module 115 adds information indicating that updating is being performed to the sticky note. For example, the update sticky note processing module 115 stores a “information indicating being updated” in the being updated field 540 of the sticky note information table 500 illustrated in the example of FIG. 5 and stores a user ID which indicates an updater in the updater field 545.

In Step S806, the update sticky note display control module 120 alters displaying to display that the sticky note is being updated.

FIG. 9 is a flowchart illustrating an example of another process performed by the exemplary embodiment (information processing apparatus 100).

In Step S902, the update sticky note processing module 115 receives a sticky note ID of a sticky note to be updated and the update contents from the personal sticky note information processing apparatus 150.

In Step S904, the update sticky note processing module 115 updates the contents of the sticky note according to the received update content. For example, the update sticky note processing module 115 updates the contents of the contents field 597 of the sticky note information table 500 illustrated in the example of FIG. 5.

In Step S906, the update sticky note display control module 120 alters the display contents of the sticky note.

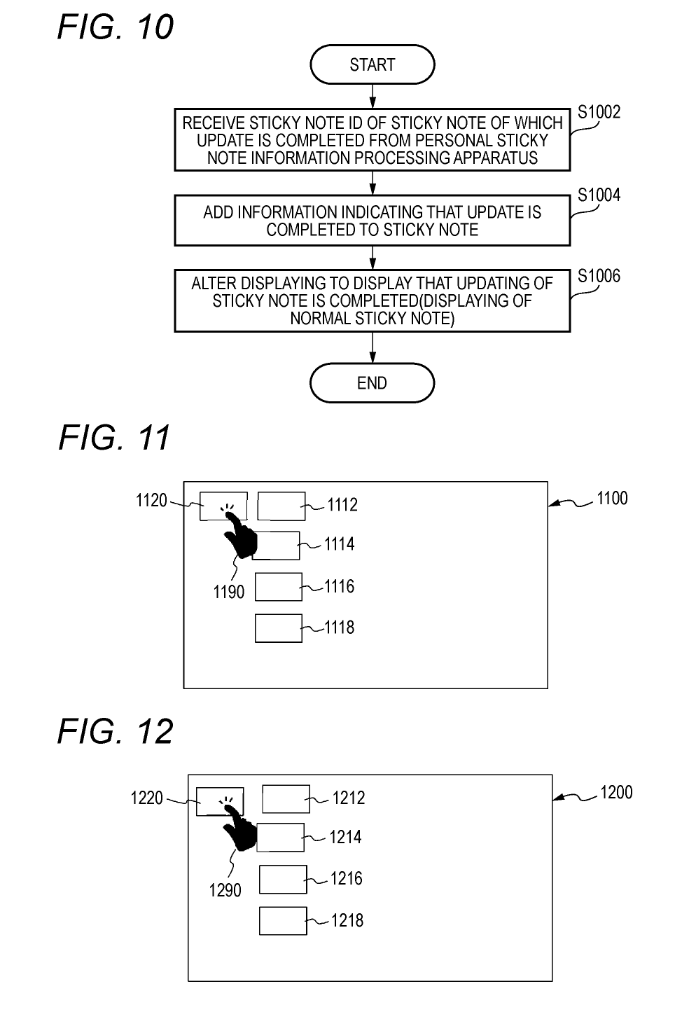

FIG. 10 is a flowchart illustrating an example of another process performed by the exemplary embodiment (information processing apparatus 100).

In Step S1002, the update sticky note processing module 115 receives a sticky note ID of a sticky note of which updating is completed from the personal sticky note information processing apparatus 150.

In Step S1004, the update sticky note processing module 115 adds information, which indicates that the updating is completed, to the sticky note. For example, the update sticky note processing module 115 stores “information indicating that updating is completed” in the being updated field 540 of the sticky note information table 500 illustrated in the example of FIG. 5. For example, the updater field 545 may be altered to be an empty field.

In Step S1006, the update sticky note display control module 120 alters displaying to display that the updating of the sticky note is completed (displaying of normal sticky note).

FIG. 11 is an explanatory diagram illustrating an example of processing performed by the exemplary embodiment (personal sticky note information processing apparatus 150). FIG. 11 illustrates an example of displaying in a terminal screen 1100 of the personal sticky note information processing apparatus 150. FIG. 11 illustrates an example of processing for sending the sticky note. A sticky note 1112, a sticky note 1114, a sticky note 1116, and a sticky note 1118 are displayed in the terminal screen 1100. A user newly creates sticky note 1120 using his/her finger 1190 for operation and performs an operation of transmitting the sticky note 1120 to the information processing apparatus 100. The sticky note 1120 is a blank paper at the first transmission time. The user continues writing into the sticky note 1120 (That is, the sticky note is being updated). The interim update contents are also transmitted to the information processing apparatus 100.

FIG. 12 is an explanatory diagram illustrating an example of another processing performed by the exemplary embodiment (information processing apparatus 100). FIG. 12 illustrates an example of displaying in a shared screen 1200 of the information processing apparatus 100. FIG. 12 illustrates an example of processing of update continuation of the sticky note. A sticky note 1212 (a sticky note corresponding to the sticky note 1112 on the shared screen 1200), a sticky note 1214 (a sticky note corresponding to the sticky note 1114 on a shared screen 1200), a sticky note 1216 (a sticky note corresponding to the sticky note 1116 on the shared screen 1200), and a sticky note 1218 (a sticky note corresponding to the sticky note 1118 on the shared screen 1200) are displayed in the shared screen 1200. The information processing apparatus 100 receives and displays the sticky note 1220 (a sticky note corresponding to the sticky note 1120 on the shared screen 1200). The sticky note 1220 is a blank paper at the first reception point in time. A facilitator places the received sticky note 1220 in a proper position using his/her finger for operation 1290. As described above, the sticky note 1120 is updated in the personal sticky note information processing apparatus 150 which transmits the sticky note 1220. The interim update contents are also transmitted to the information processing apparatus 100. Update of the sticky note 1220 continues even during replacement is performed. A display form of the sticky note 1220, which is being updated, is highlighted, for example.

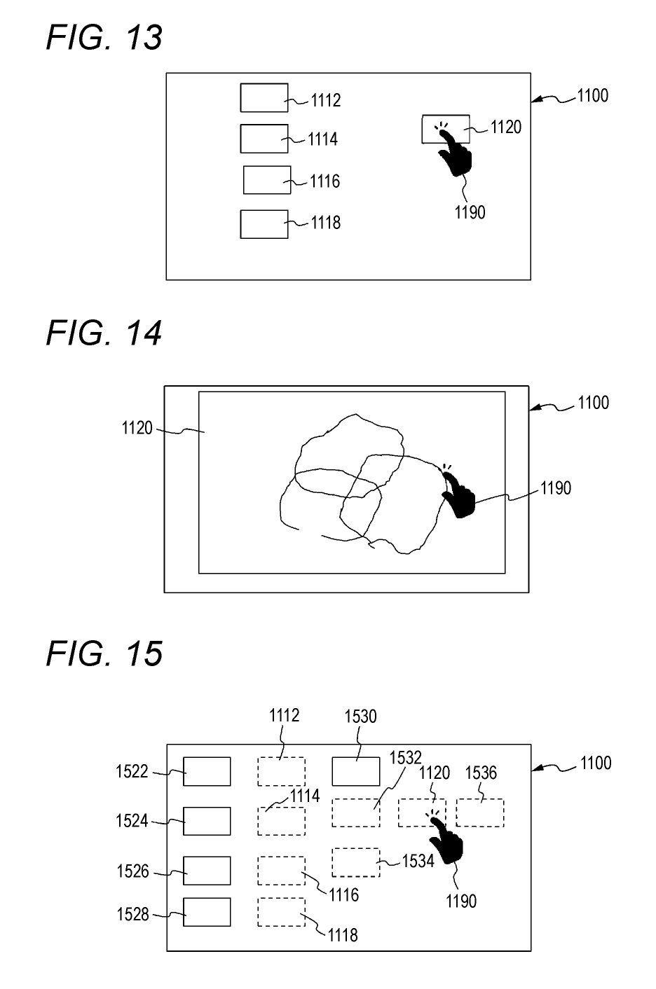

FIG. 13 is an explanatory diagram illustrating an example of another processing performed by the exemplary embodiment. FIG. 13 illustrates an example of displaying in the terminal screen 1100 of the personal sticky note information processing apparatus 150. FIG. 13 illustrates an example of processing of selecting the sticky note of the update target.

The personal sticky note information processing apparatus 150 may select (specifically, a selection operation such as a double-tap) the sticky note 1120 which is already attached on the mount (a sticky note which is not being updated) as a sticky note to be update target.

The sticky note 1112, the sticky note 1114, the sticky note 1116, the sticky note 1118, and the sticky note 1120 are displayed in the terminal screen 1100. A user may select (specifically, a selection operation such as a double-tap) the sticky note 1120 by a selection operation such as a double-tap from a group of sticky notes attached on the mount of the terminal screen 1100 using his/her finger for operation 1190 as a target to be updated. The personal sticky note information processing apparatus 150 transmits a notification that the sticky note 1120 is set as a target to be updated to the information processing apparatus 100. The user performs writing into the sticky note 1120 (That is, the sticky note is being updated). The interim update contents are also transmitted to the information processing apparatus 100.

FIG. 14 is an explanatory diagram illustrating an example of another processing performed by the exemplary embodiment. FIG. 14 illustrates an example of displaying in the terminal screen 1100 of the personal sticky note information processing apparatus 150. FIG. 14 illustrates an example of processing of updating the sticky note.

A sticky note 1120 which is designated is displayed on the terminal screen 1100 in an enlarged scale from a state illustrated in the example of FIG. 13. The user updates the sticky note 1120 using his/her finger 1190 for operation. In this example, a figure (a pen diagram) is drawn.

FIG. 15 is an explanatory diagram illustrating another example of processing performed by the exemplary embodiment. FIG. 15 illustrates an example of displaying in the terminal screen 1100 of the personal sticky note information processing apparatus 150. FIG. 15 illustrates an example of displaying of a sticky note being updated and another selection example of a sticky note to be updated.

13 sheets of sticky notes such as sticky notes 1522 are displayed in the terminal screen 1100. Among the 13 sheets of sticky notes, the sticky note 1112, the sticky note 1114, the sticky note 1116, the sticky note 1118, the sticky note 1532, the sticky note 1534, the sticky note 1120, and the sticky note 1536 are being updated by other personal sticky note information processing apparatus 150, and the frames of those sticky notes are altered into a dotted line in order to indicate the alteration state (those sticky notes are being updated). Displaying similar to displaying of the sticky notes described above is also performed in the shared screen 1200 of the information processing apparatus 100.

Here, in a case where a pinch-out operation (that is, an operation of enlarging the sticky note 1120) is performed on the sticky note 1120 by the finger 1190 for operation of the user, when a size of the sticky note 1120, which is a target to be operated, exceeds a predetermined threshold value, it is determined that the sticky note 1120 is selected as a target to be edited. Even when a sticky note is being updated by other personal sticky note information processing apparatus 150, the sticky note is able to be selected as the target to be edited.

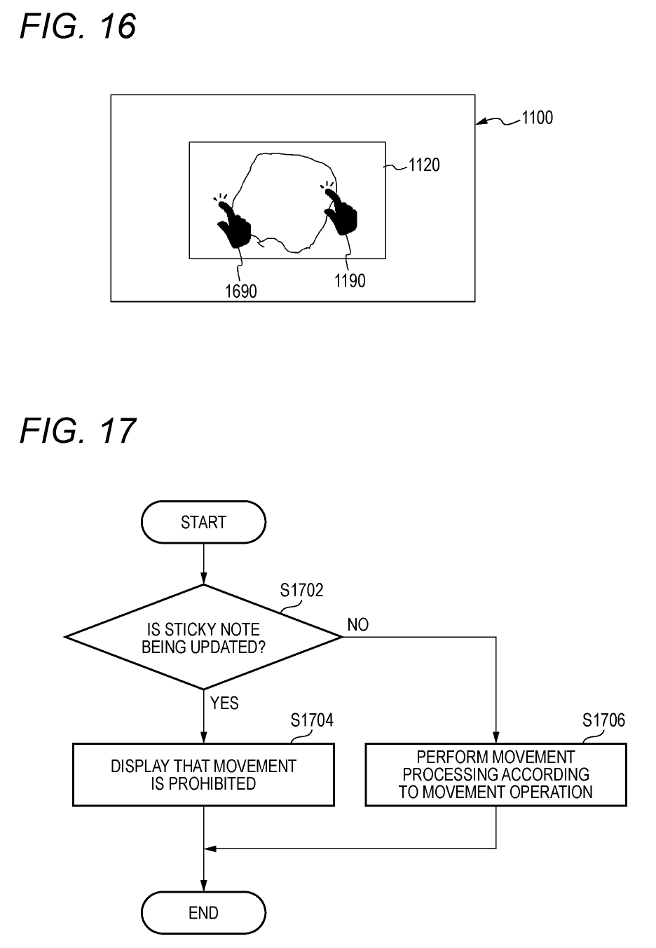

FIG. 16 is an explanatory diagram illustrating another example of processing performed by the exemplary embodiment. FIG. 16 illustrates an example of displaying in the terminal screen 1100 of the personal sticky note information processing apparatus 150. The sticky note 1120 is displayed in an enlarged scale and is edited from a state illustrated in the example of FIG. 15.

The sticky note 1120 is displayed in an enlarged scale capable of being edited in the terminal screen 1100. The sticky note 1120 is capable of being edited by the finger 1190 for operation of the user of the personal sticky note information processing apparatus 150. In FIG. 16, an appearance of the sticky note 1120 edited by the finger 1690 for operation of the user of the personal sticky note information processing apparatus 150 is displayed. The operation to be performed in other personal sticky note information processing apparatus 150 (A) may be received from the other personal sticky note information processing apparatus 150 (A) or may be received from the information processing apparatus 100.

An exclusive processing (lock processing), which does not permit editing by plural persons for a single sticky note, may be allowed to be performed on the sticky note. Only a user who has update authority is able to update a sticky note and a user who does not have the update authority is not able to update the sticky note. For that reason, in a case where an update operation is performed, it is determined whether a user who has the update authority for the sticky note is present or not.

In a case where the user who has the update authority is not present, the update authority may be given to the user who performs the update operation, and the update authority may not be given to other user until the updating is completed by the user.

FIG. 17 is a flowchart illustrating an example of another process (example of movement process of the sticky note) performed by the exemplary embodiment.

In Step S1702, it is determined whether a sticky note to be moved is the sticky note which is being updated or not. In a case where the sticky note to be moved is the sticky note being updated, the process proceeds to Step 51704 and otherwise, the process proceeds to Step S1706.

In Step S1704, the movement processing is not performed and thus, it is displayed that the movement is prohibited. That is, this is because the sticky note being updated is intended to be updated on the premise that it is a sticky note which is present in a position where an update of the sticky note is performed. That is, it is expressed that the update of the contents is performed on the sticky note which is located in the position, before the update and thus, the movement on the mount is not permitted until the updating is completed.

In Step S1706, the movement processing is performed according to the movement operation. The movement operation of the sticky note is not for the sticky note which is being updated and thus, a general movement processing is performed.

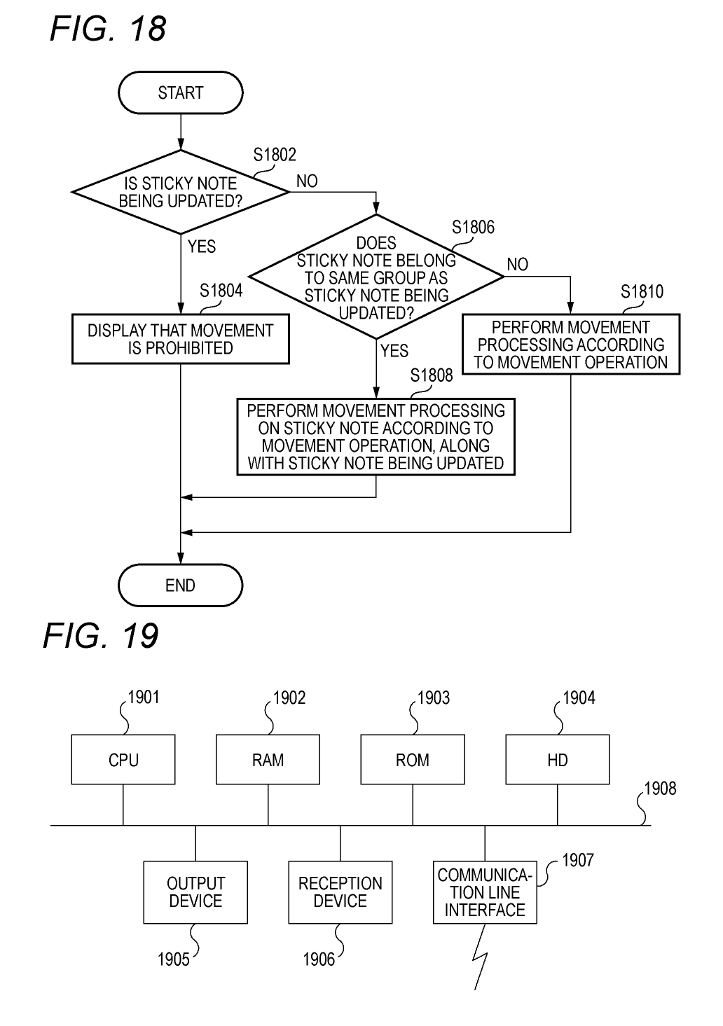

FIG. 18 is a flowchart illustrating an example of another process performed by the exemplary embodiment.

In Step S1802, it is determined whether a sticky note to be moved is the sticky note which is being updated or not. In a case where the sticky note to be moved is the sticky note which is being updated, the process proceeds to Step S1804 and otherwise, the process proceeds to Step 51806.

In Step S1804, it is displayed that the movement is prohibited is performed. The processing in Step S1804 is similar to the processing in Step S1704 illustrated in the example of FIG. 17.

In Step S1806, it is determined whether a sticky note to be moved belongs to the same group as that to which the sticky note being updated belongs. In a case where the sticky note to be moved belongs to the same group as that to which the sticky note being updated belongs, the process proceeds to Step S1808 and otherwise, the process proceeds to Step S1810. That is, it is determined whether a sticky note, which is being updated and belongs to the same group as the sticky note to be moved belongs is present. For example, it may be determined using information within the group field 570 of the sticky note information table 500 illustrated in the example of FIG. 5.

In Step S1808, the movement processing is performed on the sticky note to be moved according to the movement operation, along with the sticky note being updated. That is, even when the sticky note which is being updated is present in the same group, the sticky note to be moved is moved together with the sticky note which is being updated. The movement is performed while maintaining a positional relationship between the sticky notes within the group.

In Step S1810, the movement processing is performed according to the movement operation. The movement processing is not for the sticky note which is being updated and thus, a general movement processing is performed.

A hardware configuration of a computer, which executes a program, as the present exemplary embodiment is a general computer, specifically, a personal computer or a computer capable of becoming a server, as illustrated in FIG. 19. That is, as a specific example, a CPU 1901 is used as a processing unit (operation unit), a RAM 1902, a ROM 1903, and an HD 1904 are used as a storage device. For example, a hard disk or a solid state drive (SSD) may be used as the HD 1904. The computer is configured with the CPU 1901, the RAM 1902, the ROM 1903, the HD 1904, a reception device 1906, an output device 1905, a reception device 1906, a communication line interface 1907, and a bus 1908. The CPU 1901 executes programs such as the communication module 105, the update sticky note module 110, the update sticky note processing module 115, the update sticky note display control module 120, the communication module 155, the update sticky note module 160, the update sticky note selection module 165, the sticky note update processing module 170, the display information configuration module 205, the sticky note management module 210, the mount function management module 215, the use mount management module 220, the mount operation module 230, the sticky note creation and operation module 235, the display module 272, the mount and sticky note operation module 274, the display module 282, the mount and sticky note operation module 284, and the like. The RAM 1902 stores the program or data is stored. The ROM 1903 stores a program used for activating the computer of the present exemplary embodiment. The HD 1904 is an auxiliary storage device (which may be a flash memory or the like) having functions of the sticky note and mount information DB 240 and the operation information DB 245. The reception device 1906 receives data based on the operation of a keyboard, a mouse, a touch screen, a microphone or the like by a user. The output device 1905 is, for example, a CRT, a liquid crystal device, a speaker or the like. The communication line interface 1907 connects with a communication network interface card or the like. The bus 1908 connects the components described above and is used for exchanging data between the components. These computers may be connected with each other through a network.

Regarding matters corresponding to the computer program of the exemplary embodiments described above, a computer program which is software is read into a system having a hardware configuration of the present exemplary embodiment, and software resources and hardware resources are cooperated with each other to implement the exemplary embodiment described above.

The hardware configuration of the information processing apparatus illustrated in FIG. 19 illustrates just one configuration example, the present exemplary embodiment is not limited to the configuration illustrated in FIG. 19, and may be a configuration in which the modules described in the present exemplary embodiment are adapted to be executable. For example, some of the modules may be implemented by exclusive hardware (for example, an application specific integrated circuit (ASIC) or the like), some of the modules may be adapted to be connected by the communication line placed within an external system. Furthermore, plural systems each of which is illustrated in FIG. 19 may be connected to each other by the communication line to be cooperated with each other. In particular, the system may be incorporated into a portable information communication device (including a mobile phone, a smart phone, a mobile device, a wearable computer or the like), home information appliances, a robot, a copy machine, a facsimile, a scanner, a printer, a multifunction device (image processing apparatus equipped with functions of two or more of a scanner, a printer, a copy machine, a facsimile or the like), in addition to the personal computer.

The program described above may be provided in a state of being stored in a recording medium or be provided by a communication unit. In this case, for example, the program described above may be considered as an invention of a “computer readable recording medium having a program recorded therein”.

The “non-transitory computer readable recording medium having a program recorded therein” refers to a recording medium used for installation, execution, distribution or the like of the program, having recorded a program therein, and is readable by a computer.

The recording medium may include, for example, a digital versatile disk (DVD) such as “DVD-R, DVD-RW, DVD-RAM, or the like” that are standards formulated by the DVD forum, “DVD+R, DVD+RW, or the like” that are standards formulated by the DVD+RW, a compact disk (CD) such as a CD-read only memory (CD-ROM), a CD-recordable (CD-R), a CD-rewritable (CD-RW) or the like, a Blu-ray Disc, an magnetooptical disk (MO), a flexible disk (FD), a magnetic tape, a hard disk, a read-only memory (ROM), an electrically erasable programmable read-only memory (EEPROM (registered trademark)), a flash memory, a random access memory (RAM), a secure digital (SD) memory card, or the like.

A portion or the entirety of the program may be recorded in the recording medium to be saved or distributed. The portion or the entirety of the program may be transmitted, by communication, using a transmission medium such as a wired communication network, a wireless communication network, and a combination of the wired communication network and the wireless communication network, that are used, for example, in a local area network (LAN), a metropolitan area network (MAN), a wide area network (WAN), the Internet, the Ethernet, and an extra network, or may be carried by being superposed on a carrier wave.

Furthermore, the program may be a portion or the entirety of another program or may be recorded in the recording medium together with a separate program. The program may be divided to be recorded in plural recording media. The program may be recorded in any format such as a compressed format, an encrypted format, or the like as long as the program can be restored.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a receiving unit that receives an update notification of a content of a first sticky note attached to a mount; and
a controller that controls display of the first sticky note so that, in a case where the first sticky note is being updated, the first sticky note is displayed in a manner indicating that the first sticky note is being updated.

2. The information processing apparatus according to claim 1,
wherein the controller controls the display of the first sticky note so that, in a case where the first sticky note is being updated, a position of the first sticky note is fixed until updating of the first sticky note is completed.

3. The information processing apparatus according to claim 1,
wherein, in a case where a second sticky note associated with the first sticky note are moved and the first sticky note is being updated, the controller controls the display of the first sticky note so that the first sticky note is moved while maintaining a positional relationship between the first sticky note and the second sticky note.

4. The information processing apparatus according to claim 2,
wherein, in a case where a second sticky note associated with the first sticky note are moved and the first sticky note is being updated, the controller controls the display of the first sticky note so that the first sticky note is moved while maintaining a positional relationship between the first sticky note and the second sticky note.

5. An information processing method comprising:
receiving an update notification of a content of a first sticky note attached to a mount; and
controlling display of the first sticky note so that, in a case where the first sticky note is being updated, the first sticky note is displayed in a manner indicating that the first sticky note is being updated.

6. A non-transitory computer readable medium storing a computer to execute information processing comprising:
receiving an update notification of a content of a first sticky note attached to a mount; and
controlling display of the first sticky note so that, in a case where the first sticky note is being updated, the first sticky note is displayed in a manner indicating that the first sticky note is being updated.
